(19) United States
(12) Patent Application Publication
(10) Pub. No.: US 2008/0033940 A1
(43) Pub. Date: Feb. 7, 2008

(54) Database Query Enabling Selection By Partial Column Name

(76) Inventors: Hung The Dinh, Austin, TX (US); Teng Hu, Austin, TX (US); Phong Anh Pham, Austin, TX (US)

Correspondence Address: IBM CORPORATION (RHF), C/O ROBERT H. FRANTZ, P. O. BOX 23324, OKLAHOMA CITY, OK, 73123, US

(21) Appl. No.: 11/461,539

(22) Filed: Aug. 1, 2006

(51) Int. Cl. G06F 17/30

(52) U.S. Cl. 707/6

(57) ABSTRACT

A system and method for allowing selection of data columns from a database or data table by specifying a partial column name, such as an improved or extended Structured Query Language (SQL) SELECT command, by first determining if a partial column name has been specified in a phrase or option of the command, then by extracting a targeted database or data table name from the command, searching a database system catalog to find one or more column names matching the partial name specification, selecting data from one or more columns having the matching name or names in said targeted database or data table, and returning the selected data to the requester.

### CROSS-REFERENCE TO RELATED APPLICATIONS (CLAIMING BENEFIT UNDER 35 U.S.C. 120)

None.

### FEDERALLY SPONSORED RESEARCH AND DEVELOPMENT STATEMENT

This invention was not developed in conjunction with any Federally sponsored contract.

### MICROFICHE APPENDIX

Not applicable.

### INCORPORATION BY REFERENCE

Chapter 4 “Queries” of the book “DB2 Universal Database for iSeries SQL Reference, Version 5, Release 3”, pp. 359-390, Sixth Edition, August, 2005, published online by IBM Corporation http://publib<dot>boulder<dot>ibm<dot>com/infocenter/iseries/v5r3 where <dot> indicates a period or dot “.” character in a Universal Resource Locator (“URL”) address.

### BACKGROUND OF THE INVENTION

1. Field of the Invention

This invention pertains to technologies employed to query databases, extract information from databases, and to explore the contents of databases.

2. Background of the Invention

Modern databases, also known as relational databases, organize large amounts of data into records and fields, which each record contains one or more fields, and all records have the same set of fields associated with them. The values stored in each field of each record can contain numeric values, such as integers or real numbers, character strings, or even hyperlinks.

A common format of visualizing or representing a database is in a tabular format (50), as shown in FIG. 5a. The values V_{1,1}-V_{m,n} are stored in the cells of the “table”, where the table represents the entire database. Each “column” C₁-Cₙ corresponds to a field, and each “row” corresponds to a record R₁-Rₘ in the database. Thus, as in this example, a database can have at least two dimensions: m and n. And, each data value stored in the database can be identified by its unique coordinate pair of dimensional values.

A more practical example of an employee information database is shown (52) in FIG. 5b. In this example, each record contains fields for the employee's first name, last name, home phone number, age, . . . , department, and location, corresponding to C₁-Cₙ. This example shows some hypothetical data values (53) for some employees for a database which might be called “XYZ_Corp_Personnel”.

As databases become larger and more difficult to manage, International Business Machines (“IBM”) developed a set of tools, programming paradigms, and software products referred to as Relational Database Management Systems (“RDBMS”), including DataBase 2, now universally referred to as “DB2”. A language for finding and extracting data from databases was developed, called Structured English Query Language, or “SEQUEL”. As this language was developed further, and widely adopted throughout the information technology industry, it became an independently managed, open standard, now known as Structured Query Language, or just “SQL”. Many database vendors have adopted SQL, some with proprietary extensions, including Oracle, Microsoft, Sybase, MySQL AB, and PostgreSQL from the University of California at Berkeley. IBM continues to develop and promote SQL, and ANSI has taken the lead in managing an open standard for SQL.

One of the most-used commands in SQL is the SELECT command, having a command-line syntax such as this:

SELECT <column_list> FROM <table_name> ;

where <column_list> indicates which column or field values are to be selected for display or extraction from a database named <table_name>. For example, to select the first names and last names from the example XYZ_Corp_Personnel database, a command such as this would work:

SELECT f_name, l_name FROM XYZ_Corp_Personnel;

Over many years of development, quite a few options to the interactive SQL SELECT command have been added to various implementations of the language, including abilities to re-order data during the selection, or to join tables during a selection. For example, IBM's SQL for the iSeries platforms SELECT command has optional “where”, “group-by”, and “having” clauses. Each of these commands, however, require the user to know the exact spelling of each column or field name which he or she wishes to select.

Therefore, as the SQL is widely used, and as the SQL SELECT command is one of the most relied-upon commands in the SQL language, there is a need in the art for efficient improvements and enhancements to the SELECT command to allow for less-than-exact column or field specification in the command.

### BRIEF DESCRIPTION OF THE DRAWINGS

The following detailed description when taken in conjunction with the figures presented herein provide a complete disclosure of the invention.

FIG. 1 depicts an embodiment of the invention as additional functionality to an SQL database engine.

FIGS. 2a and 2b show a generalized computing platform architecture, and a generalized organization of software and firmware of such a computing platform architecture.

FIG. 3a sets forth a logical process to deploy software to a client in which the deployed software embodies the methods and processes of the present invention.

FIG. 3b sets for a logical process to integrate software to other software programs in which the integrated software embodies the methods and processes of the present invention.

FIG. 3c sets for a logical process to execute software on behalf of a client in an On-Demand computing system, in which the executed software embodies the methods and processes of the present invention.

FIG. 3d sets for a logical process to deploy software to a client via a virtual private network, in which the deployed software embodies the methods and processes of the present invention.

FIGS. 4a, 4b and 4c, illustrate computer readable media of various removable and fixed types, signal transceivers, and parallel-to-serial-to-parallel signal circuits.

FIG. 5a shows a generalized example visualization of a relational database as a table of data.

FIG. 5b shows a more specific example visualization of a hypothetical relational database as a table of data.

FIG. 6 illustrates the components and arrangement of a typical database system including a query engine.

FIG. 7 sets forth a logical process according to the invention.

### SUMMARY OF THE INVENTION

The present invention provides a system and method for allowing selection of data columns from a database or data table by specifying a partial column name, such as an improved or extended Structured Query Language (SQL) SELECT command, by first determining if a partial column name has been specified in a phrase or option of the command, then by extracting a targeted database or data table name from the command, searching a database system catalog to find one or more column names matching the partial name specification, selecting data from one or more columns having the matching name or names in said targeted database or data table, and returning the selected data to the requester.

### DETAILED DESCRIPTION OF THE INVENTION

The inventors of the present invention have recognized a problem unaddressed in the art regarding the SQL SELECT command wherein many options are available to allow the SELECT command to find specific data, but one of the parameters, namely the <column_list> parameter, requires exact identification of column or field names in order to operate. For example, if an administrator is unfamiliar with the detailed design of a database which contains a column named “residence_address”, the administrator must take several steps to display the names of all the columns, search through the names to find all of those related to addresses, and determine which, if any, contain the needed information. Then, the administrator must type the SELECT command including the column name exactly correctly.

Recognizing this problem and inefficiency in the SQL language, the inventors have developed a means and method for selecting one or more fields of information from relational databases using partially-specified column names, wherein all columns whose names match the partial specification are selected, thereby avoiding the need to know the exact names of the database columns.

### Database Servers and SOL SELECT Command

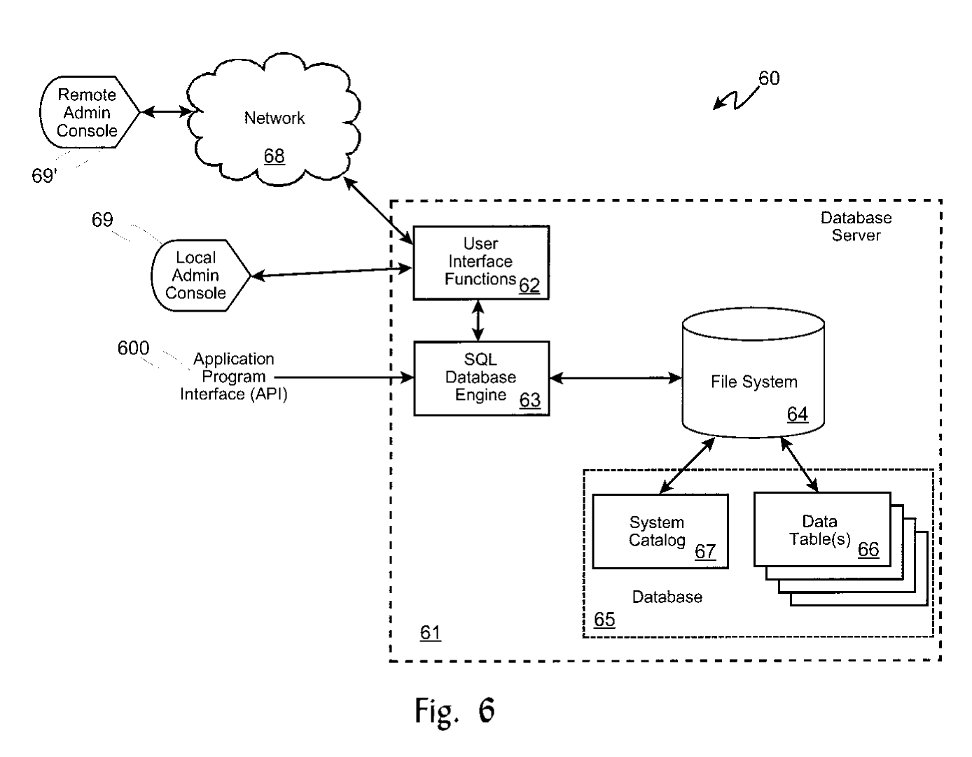

Turning to FIG. 6, a generalized system diagram (60) of a database server is shown, which applies to a wide variety of systems, such as IBM's DB2 systems, as well as those offered by Oracle, Microsoft, and others. The database server (61) typically has a number of user interface functions (62) for communicating with a local administration console (69), or with a remote administration console (69′) via a network (68). More recently, the remote consoles comprise web browsers connected via an intranet, WAN or the internet. Historically, remote consoles have included dumb terminals (e.g. “V.22 terminals”) connected via a dedicated data link or a modem. As such, the user interface functions (62) shown here represent the necessary functions to interface to the appropriate terminal, such as a Hyper Text Transfer Protocol (“HTTP”) server, a modem interface, etc.

An engine (63) interprets SQL commands received from the administration console, and performs searches, data extraction, deletions, changes, and other data operations to the database (65) which is stored in a computing platform's file system (64). In practice, the actual database data table files may be stored together on just one disk, or they may be distributed among multiple storage media, some of which may be remotely connected via a network. A system catalog (67) contains information necessary to locate the data table files (66), and to interpret the contents of the tables, such as the column names, the field or column content attributes and limits, etc.

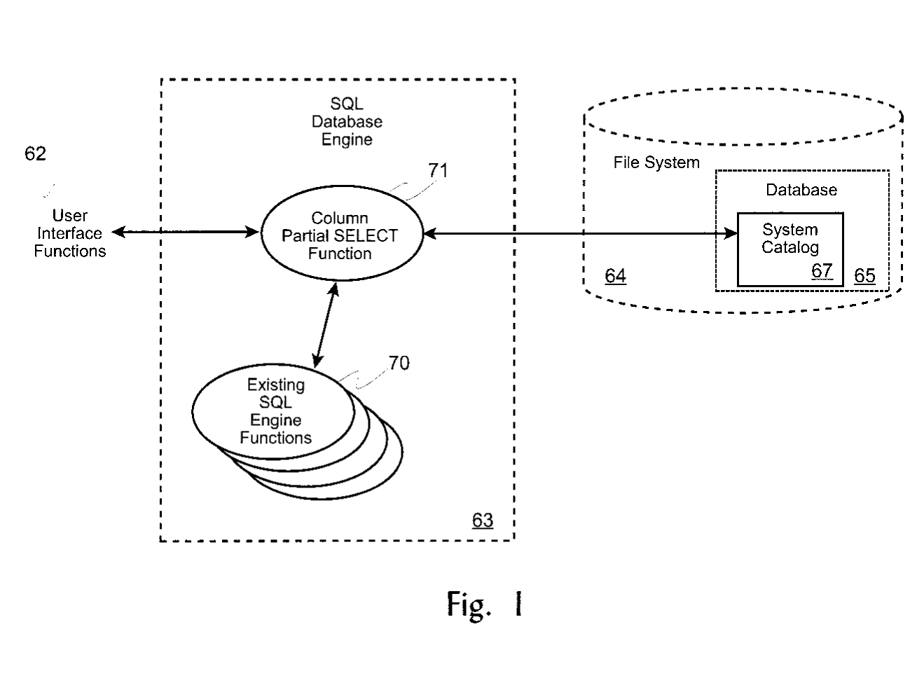

FIG. 1 provides more details of the engine (63), which preferably includes the previously-provided SQL engine functions (70), as well as a new function for selection of data through specification of partial column names (71). The new partial column select function (71) preferably accesses one or more system catalogs (67) for databases (65) as described in the following paragraphs. In this embodiment, the software code of an existing SQL engine, such as the IBM SQL UDB engine, is modified to incorporate the logical processes of the present invention. It will be recognized by those skilled in the art that similar modifications can be made to alternate SQL engines, and that other embodiments include stand-alone software, circuitry, or both.

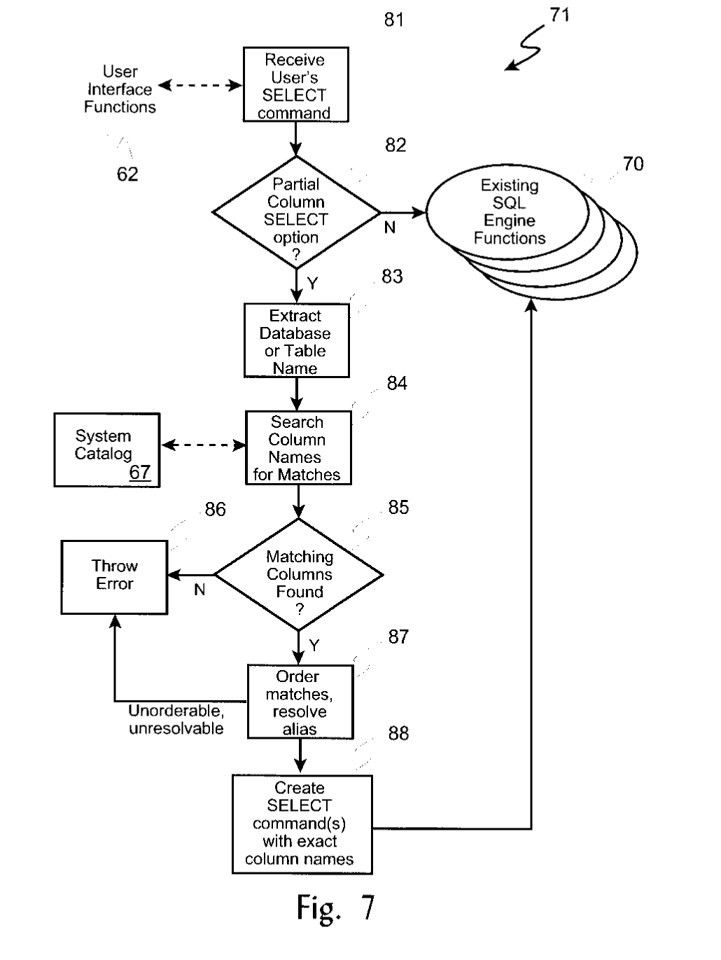

FIG. 7 shows a logical process (71) according to the invention which is preferably embodied in the partial column name SELECT function. A user's SELECT command is received (81) from the system console or a remote console, and the command phrases and options are parsed to determine if a partial column name has been specified (82). If not, then the SELECT command is processed normally (70). Otherwise, if a partial column name has been specified (82), then the target database or table (e.g. a “from” phrase) is extracted from the SELECT command, and the system catalog (67) for the targeted database is accessed and searched for matching column names.

If no matches are found (85), then an error is preferably thrown. If more than one match is found, the columns are ordered and any name alias are resolved (87), as needed, according to one or more configurable preferences. For example, if more than one column name matches the partial name specification, then the columns can be returned based on the order sequence defined at creation time of the table or database. Alternatively, they may be returned in ascending or descending alphabetical order, numerical order, or alpha-numerical order, for example. If the user has employed an SQL alias name option in which a new name is assigned to an existing column name, and if more than one column matches more than one existing column name and/or alias names, then an error is preferably thrown (86). Finally, if a partial column specification is devoid of any qualifiers except a specially designated wildcard character, then all columns are selected (e.g. normal operation of the pre-existing SELECT all function).

If only one column name matches the specified partial column name, or after all multiple matches have been ordered and resolved, one or more SELECT commands are created (88) which contain the exact column names in full form (e.g. not partially specified, and spelled exactly as they appear in the system catalog). These SELECT commands, in legacy form, are then preferably submitted to the existing SQL engine functions (70) for processing which results in the selection and display of the columns of the targeted database which match the partial column name specification.

### Example Partial Column Name Specification

According to the present invention, a command-line syntax for an SQL SELECT command is extended to include an optional phrase for partially specifying one or more column names for selection. For example, consider a first table TABLE_A which has the following columns:

USERID, USERNAME, FIRST_NAME, LAST_NAME, CITY, STATE,
ZIPCODE

Per the new process, the user could enter a SELECT command as follows, where the percent “%” character is designated as a wildcard character:

SELECT %USER%, %NAME, ZIP% FROM TABLE_A;

which would efficiently and effectively select the same columns as the fully-specified command:

SELECT USERID, USERNAME, FIRST_NAME, LAST_NAME,
ZIPCODE FROM TABLE_A;

without requiring the user to know the full, exact name of the columns selected. The improved SELECT command with partial column name specification is 33% shorter than the traditional syntax, and therefore is much more efficient and easier to use. Even greater gains in efficiency and convenience are realized in practice where SELECT commands often include many more column names and optional phrases.

The previous example employed a percent “%” character to represent a wildcard character or string of characters. In practice, any character or printable symbol can be used for this purpose. Additionally, characters or printable symbols may be used to specify only one character to be matched, instead of specifying strings of any length.

For example, the percent character “%” could be used to designate one or more non-matching characters in a column name, while the ampersand symbol “&” could be used to specify a single non-matching character in a column name. This would allow more precise specification of partial column names. In this manner, the command:

SELECT F%NAME FROM TABLE_A;

would select the FIRST_NAME column, but not the LAST_NAME column. More precisely, the command:

SELECT USER&& FROM TABLE_A;

would select the column named USERID, but not the column named USERNAME.

It will be readily recognized by those skilled in the art that these exemplary embodiments of the command line syntax do not represent the limitations of the invention, and that many alternate forms for syntax exist within the invention.

### Suitable Computing Platform

In one embodiment of the invention, the functionality of the partial column name SELECT command, including the previously described logical processes, are performed in part or wholly by software executed by a computer, such as personal computers, web servers, web browsers, or even an appropriately capable portable computing platform, such as personal digital assistant (“PDA”), web-enabled wireless telephone, or other type of personal information management (“PIM”) device.

Therefore, it is useful to review a generalized architecture of a computing platform which may span the range of implementation, from a high-end web or enterprise server platform, to a personal computer, to a portable PDA or web-enabled wireless phone.

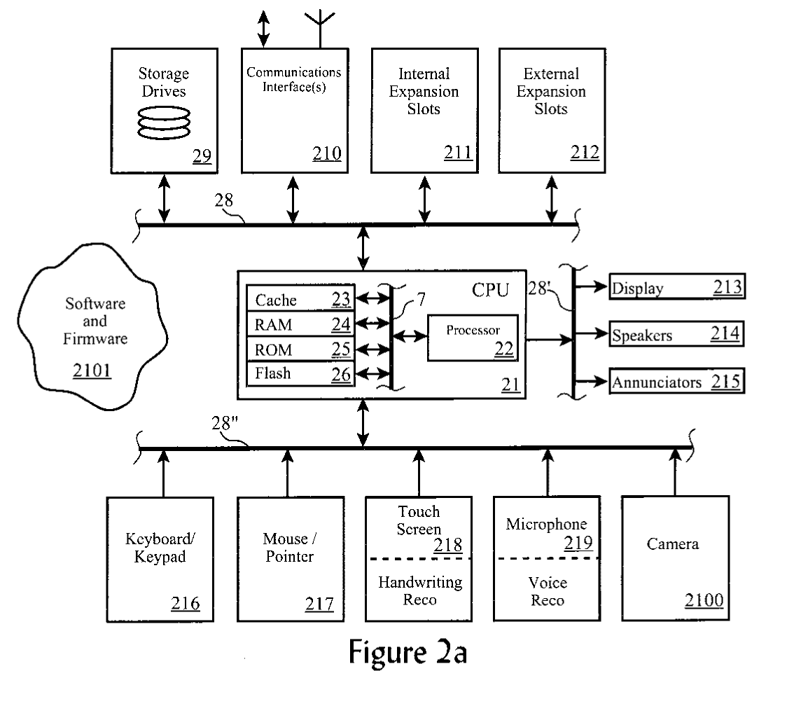

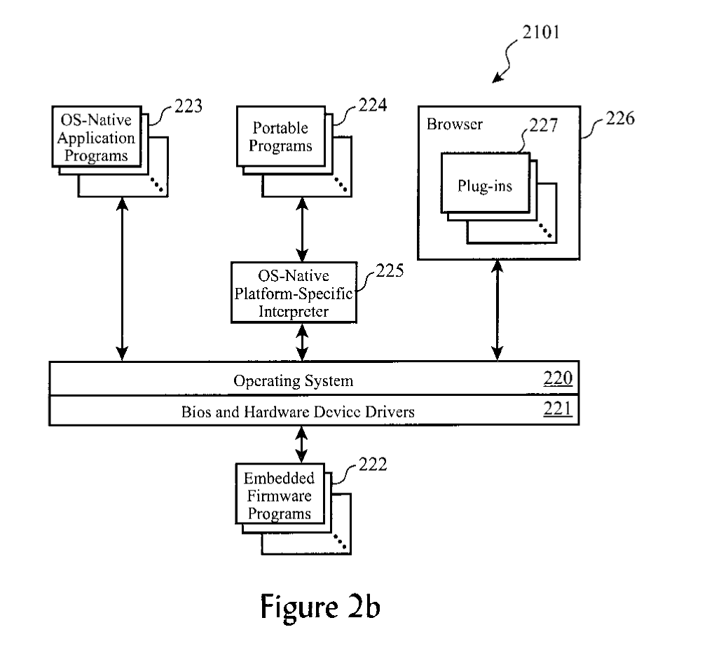

Turning to FIG. 2a, a generalized architecture is presented including a central processing unit (21) (“CPU”), which is typically comprised of a microprocessor (22) associated with random access memory (“RAM”) (24) and read-only memory (“ROM”) (25). Often, the CPU (21) is also provided with cache memory (23) and programmable FlashROM (26). The interface (27) between the microprocessor (22) and the various types of CPU memory is often referred to as a “local bus”, but also may be a more generic or industry standard bus.

Many computing platforms are also provided with one or more storage drives (29), such as hard-disk drives (“HDD”), floppy disk drives, compact disc drives (CD, CD-R, CD-RW, DVD, DVD-R, etc.), and proprietary disk and tape drives (e.g., Iomega Zip™ and Jaz™, Addonics SuperDisk™, etc.). Additionally, some storage drives may be accessible over a computer network.

Many computing platforms are provided with one or more communication interfaces (210), according to the function intended of the computing platform. For example, a personal computer is often provided with a high speed serial port (RS-232, RS-422, etc.), an enhanced parallel port (“EPP”), and one or more universal serial bus (“USB”) ports. The computing platform may also be provided with a local area network (“LAN”) interface, such as an Ethernet card, and other high-speed interfaces such as the High Performance Serial Bus IEEE-1394.

Computing platforms such as wireless telephones and wireless networked PDA's may also be provided with a radio frequency (“RF”) interface with antenna, as well. In some cases, the computing platform may be provided with an infrared data arrangement (“IrDA”) interface, too.

Computing platforms are often equipped with one or more internal expansion slots (211), such as Industry Standard Architecture (“ISA”), Enhanced Industry Standard Architecture (“EISA”), Peripheral Component Interconnect (“PCI”), or proprietary interface slots for the addition of other hardware, such as sound cards, memory boards, and graphics accelerators.

Additionally, many units, such as laptop computers and PDA's, are provided with one or more external expansion slots (212) allowing the user the ability to easily install and remove hardware expansion devices, such as PCMCIA cards, SmartMedia cards, and various proprietary modules such as removable hard drives, CD drives, and floppy drives.

Often, the storage drives (29), communication interfaces (210), internal expansion slots (211) and external expansion slots (212) are interconnected with the CPU (21) via a standard or industry open bus architecture (28), such as ISA, EISA, or PCI. In many cases, the bus (28) may be of a proprietary design.

A computing platform is usually provided with one or more user input devices, such as a keyboard or a keypad (216), and mouse or pointer device (217), and/or a touch-screen display (218). In the case of a personal computer, a full size keyboard is often provided along with a mouse or pointer device, such as a track ball or TrackPoint™. In the case of a web-enabled wireless telephone, a simple keypad may be provided with one or more function-specific keys. In the case of a PDA, a touch-screen (218) is usually provided, often with handwriting recognition capabilities.

Additionally, a microphone (219), such as the microphone of a web-enabled wireless telephone or the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device (2100), such as a still digital camera or full motion video digital camera.

One or more user output devices, such as a display (213), are also provided with most computing platforms. The display (213) may take many forms, including a Cathode Ray Tube (“CRT”), a Thin Flat Transistor (“TFT”) array, or a simple set of light emitting diodes (“LED”) or liquid crystal display (“LCD”) indicators.

One or more speakers (214) and/or annunciators (215) are often associated with computing platforms, too. The speakers (214) may be used to reproduce audio and music, such as the speaker of a wireless telephone or the speakers of a personal computer. Annunciators (215) may take the form of simple beep emitters or buzzers, commonly found on certain devices such as PDAs and PIMs.

These user input and output devices may be directly interconnected (28′, 28″) to the CPU (21) via a proprietary bus structure and/or interfaces, or they may be interconnected through one or more industry open buses such as ISA, EISA, PCI, etc.

The computing platform is also provided with one or more software and firmware (2101) programs to implement the desired functionality of the computing platforms.

Turning to now FIG. 2b, more detail is given of a generalized organization of software and firmware (2101) on this range of computing platforms. One or more operating system (“OS”) native application programs (223) may be provided on the computing platform, such as word processors, spreadsheets, contact management utilities, address book, calendar, email client, presentation, financial and bookkeeping programs.

Additionally, one or more “portable” or device-independent programs (224) may be provided, which must be interpreted by an OS-native platform-specific interpreter (225), such as Java™ scripts and programs.

Often, computing platforms are also provided with a form of web browser or micro-browser (226), which may also include one or more extensions to the browser such as browser plug-ins (227).

The computing device is often provided with an operating system (220), such as Microsoft Windows™, UNIX, IBM OS/2™, IBM AIX™, open source LINUX, Apple's MAC OS™, or other platform specific operating systems. Smaller devices such as PDA's and wireless telephones may be equipped with other forms of operating systems such as real-time operating systems (“RTOS”) or Palm Computing's PalmOS™.

A set of basic input and output functions (“BIOS”) and hardware device drivers (221) are often provided to allow the operating system (220) and programs to interface to and control the specific hardware functions provided with the computing platform.

Additionally, one or more embedded firmware programs (222) are commonly provided with many computing platforms, which are executed by onboard or “embedded” microprocessors as part of the peripheral device, such as a micro controller or a hard drive, a communication processor, network interface card, or sound or graphics card.

As such, FIGS. 2a and 2b describe in a general sense the various hardware components, software and firmware programs of a wide variety of computing platforms, including but not limited to personal computers, PDAs, PIMs, web-enabled telephones, and other appliances such as WebTV™ units. As such, we now turn our attention to disclosure of the present invention relative to the processes and methods preferably implemented as software and firmware on such a computing platform. It will be readily recognized by those skilled in the art that the following methods and processes may be alternatively realized as hardware functions, in part or in whole, without departing from the spirit and scope of the invention.

### Service-Based Embodiments

Alternative embodiments of the present invention include some or all of the foregoing logical processes and functions of the invention being provided by configuring software, deploying software, downloading software, distributing software, or remotely serving clients in an On-Demand environment.

Software Deployment Embodiment. According to one embodiment of the invention, the methods and processes of the invention are distributed or deployed as a service by a service provider to a client's computing system(s).

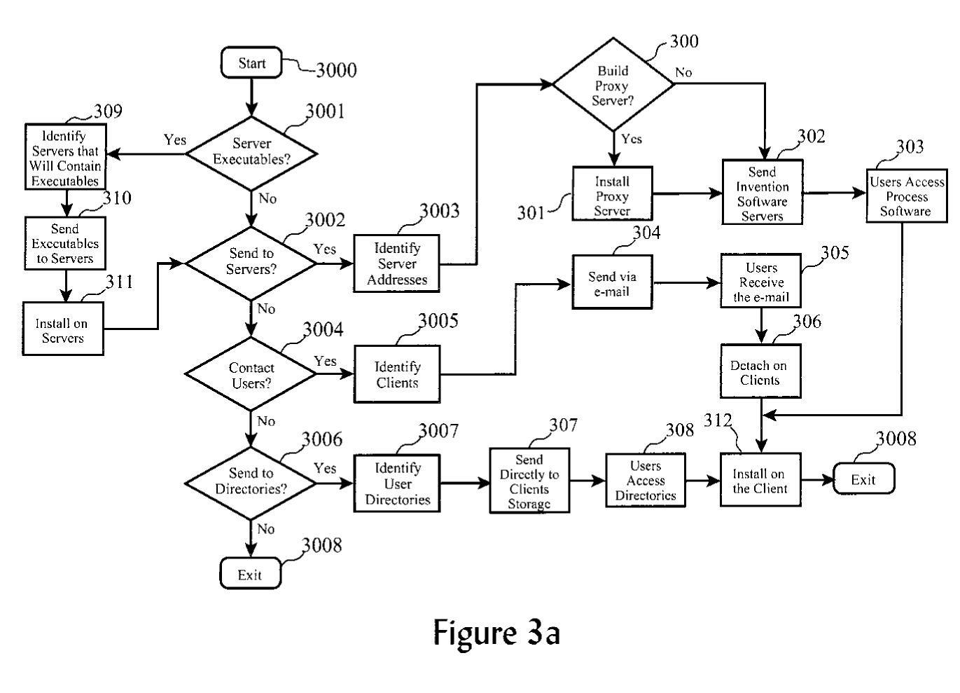

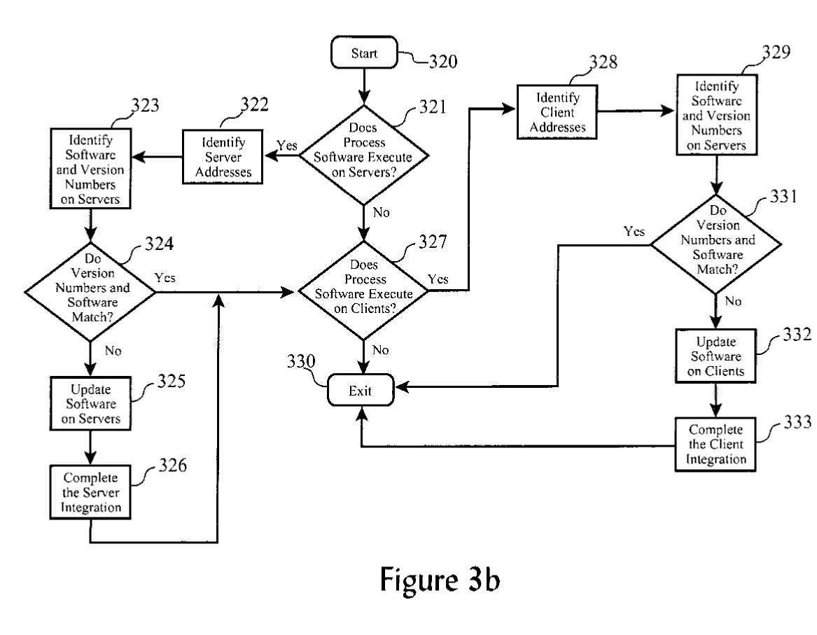

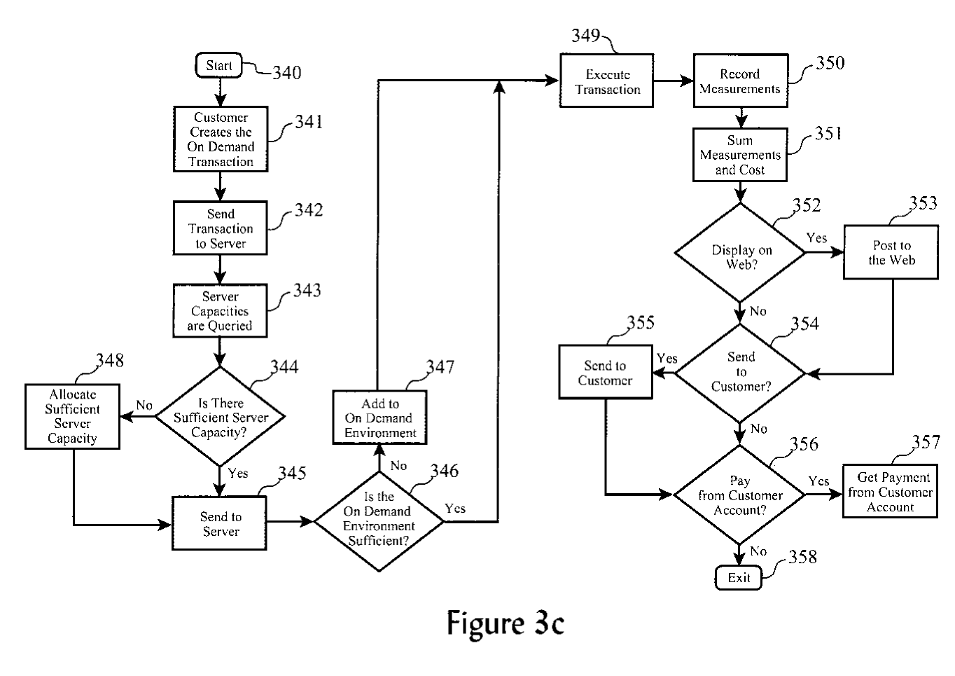

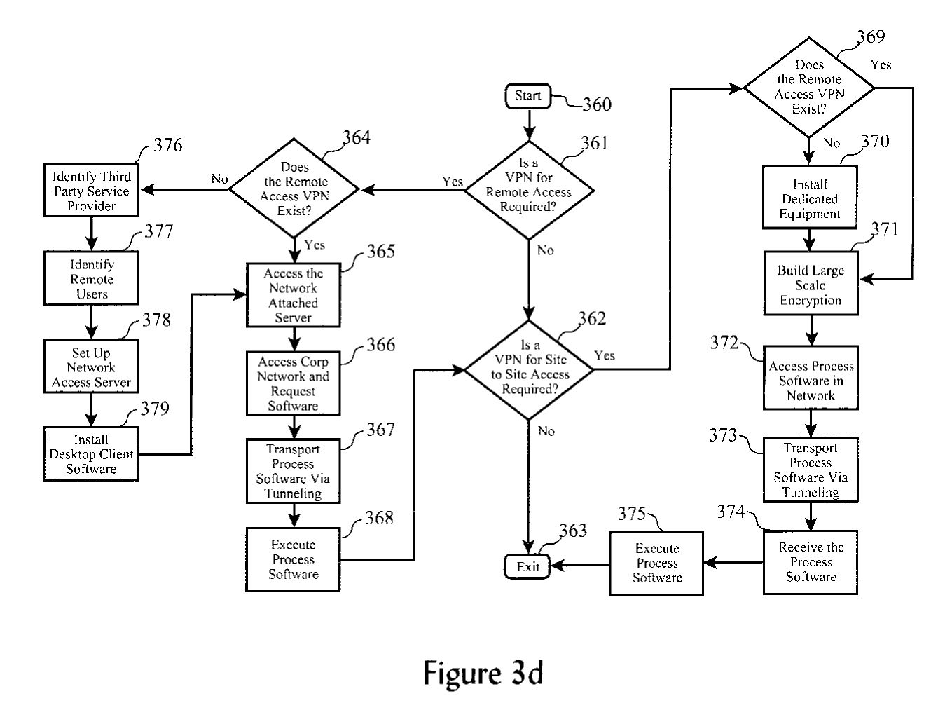

Turning to FIG. 3a, the deployment process begins (3000) by determining (3001) if there are any programs that will reside on a server or servers when the process software is executed. If this is the case then the servers that will contain the executables are identified (309). The process software for the server or servers is transferred directly to the servers storage via FTP or some other protocol or by copying through the use of a shared files system (310). The process software is then installed on the servers (311).

Next a determination is made on whether the process software is to be deployed by having users access the process software on a server or servers (3002). If the users are to access the process software on servers then the server addresses that will store the process software are identified (3003).

In step (3004) a determination is made whether the process software is to be developed by sending the process software to users via e-mail. The set of users where the process software will be deployed are identified together with the addresses of the user client computers (3005). The process software is sent via e-mail to each of the user's client computers. The users then receive the e-mail (305) and then detach the process software from the e-mail to a directory on their client computers (306). The user executes the program that installs the process software on his client computer (312) then exits the process (3008).

A determination is made if a proxy server is to be built (300) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required then the proxy server is installed (301). The process software is sent to the servers either via a protocol such as FTP or it is copied directly from the source files to the server files via file sharing (302). Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems (303). Another embodiment is to have the servers automatically copy the process software to each client and then run the installation program for the process software at each client computer. The user executes the program that installs the process software on his client computer (312) then exits the process (3008).

Lastly, a determination is made on whether the process software will be sent directly to user directories on their client computers (3006). If so, the user directories are identified (3007). The process software is transferred directly to the user's client computer directory (307). This can be done in several ways such as, but not limited to, sharing of the file system directories and then copying from the sender's file system to the recipient user's file system or alternatively using a transfer protocol such as File Transfer Protocol (“FTP”). The users access the directories on their client file systems in preparation for installing the process software (308). The user executes the program that installs the process software on his client computer (312) then exits the process (3008).

Software Integration Embodiment. According to another embodiment of the present invention, software embodying the methods and processes disclosed herein are integrated as a service by a service provider to other software applications, applets, or computing systems.

Integration of the invention generally includes providing for the process software to coexist with applications, operating systems and network operating systems software and then installing the process software on the clients and servers in the environment where the process software will function.

Generally speaking, the first task is to identify any software on the clients and servers including the network operating system where the process software will be deployed that are required by the process software or that work in conjunction with the process software. This includes the network operating system that is software that enhances a basic operating system by adding networking features. Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

Turning to FIG. 3b, details of the integration process according to the invention are shown. Integrating begins (320) by determining if there are any process software programs that will execute on a server or servers (321). If this is not the case, then integration proceeds to (327). If this is the case, then the server addresses are identified (322). The servers are checked to see if they contain software that includes the operating system (“OS”), applications, and network operating systems (“NOS”), together with their version numbers, that have been tested with the process software (323). The servers are also checked to determine if there is any missing software that is required by the process software (323).

A determination is made if the version numbers match the version numbers of OS, applications and NOS that have been tested with the process software (324). If all of the versions match and there is no missing required software, the integration continues in (327).

If one or more of the version numbers do not match, then the unmatched versions are updated on the server or servers with the correct versions (325). Additionally, if there is missing required software, then it is updated on the server or servers (325). The server integration is completed by installing the process software (326).

Step (327) which follows either (321), (324), or (326) determines if there are any programs of the process software that will execute on the clients. If no process software programs execute on the clients, the integration proceeds to (330) and exits. If this is not the case, then the client addresses are identified (328).

The clients are checked to see if they contain software that includes the operating system (“OS”), applications, and network operating systems (“NOS”), together with their version numbers, that have been tested with the process software (329). The clients are also checked to determine if there is any missing software that is required by the process software (329).

A determination is made if the version numbers match the version numbers of OS, applications and NOS that have been tested with the process software 331. If all of the versions match and there is no missing required software, then the integration proceeds to (330) and exits.

If one or more of the version numbers do not match, then the unmatched versions are updated on the clients with the correct versions (332). In addition, if there is missing required software then it is updated on the clients (332). The client integration is completed by installing the process software on the clients (333). The integration proceeds to (330) and exits.

Application Programming Interface Embodiment. In another embodiment, the invention may be realized as a service or functionality available to other systems and devices via an Application Programming Interface (“API”). One such embodiment is to provide the service to a client system from a server system as a web service.

On-Demand Computing Services Embodiment. According to another aspect of the present invention, the processes and methods disclosed herein are provided through an On-Demand computing architecture to render service to a client by a service provider.

Turning to FIG. 3c, generally speaking, the process software embodying the methods disclosed herein is shared, simultaneously serving multiple customers in a flexible, automated fashion. It is standardized, requiring little customization and it is scaleable, providing capacity On-Demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally, the assessed server may make requests of other servers that require CPU units. CPU units are an example that represents but one measurement of use. Other measurements of use include but are not limited to network bandwidth, memory usage, storage usage, packet transfers, complete transactions, etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to effect the performance of that server, other servers are accessed to increase the capacity and to share the workload. Likewise when other measurements of use such as network bandwidth, memory usage, storage usage, etc. approach a capacity so as to effect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and/or indicated on a web site accessed by the computer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

FIG. 3c sets forth a detailed logical process which makes the present invention available to a client through an On-Demand process. A transaction is created that contains the unique customer identification, the requested service type and any service parameters that further specify the type of service (341). The transaction is then sent to the main server (342). In an On-Demand environment the main server can initially be the only server, then as capacity is consumed other servers are added to the On-Demand environment.

The server central processing unit (“CPU”) capacities in the On-Demand environment are queried (343). The CPU requirement of the transaction is estimated, then the servers available CPU capacity in the On-Demand environment are compared to the transaction CPU requirement to see if there is sufficient CPU available capacity in any server to process the transaction (344). If there is not sufficient server CPU available capacity, then additional server CPU capacity is allocated to process the transaction (348). If there was already sufficient available CPU capacity, then the transaction is sent to a selected server (345).

Before executing the transaction, a check is made of the remaining On-Demand environment to determine if the environment has sufficient available capacity for processing the transaction. This environment capacity consists of such things as, but not limited to, network bandwidth, processor memory, storage etc. (345). If there is not sufficient available capacity, then capacity will be added to the On-Demand environment (347). Next, the required software to process the transaction is accessed, loaded into memory, then the transaction is executed (349).

The usage measurements are recorded (350). The usage measurements consists of the portions of those functions in the On-Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (351).

If the customer has requested that the On-Demand costs be posted to a web site (352), then they are posted (353). If the customer has requested that the On-Demand costs be sent via e-mail to a customer address (354), then they are sent (355). If the customer has requested that the On-Demand costs be paid directly from a customer account (356), then payment is received directly from the customer account (357). The last step is to exit the On-Demand process.

Grid or Parallel Processing Embodiment. According to another embodiment of the present invention, multiple computers are used to simultaneously process individual audio tracks, individual audio snippets, or a combination of both, to yield output with less delay. Such a parallel computing approach may be realized using multiple discrete systems (e.g. a plurality of servers, clients, or both), or may be realized as an internal multiprocessing task (e.g. a single system with parallel processing capabilities).

VPN Deployment Embodiment. According to another aspect of the present invention, the methods and processes described herein may be embodied in part or in entirety in software which can be deployed to third parties as part of a service, wherein a third party VPN service is offered as a secure deployment vehicle or wherein a VPN is build On-Demand as required for a specific deployment.

A virtual private network (“VPN”) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (“ESP”) sets a network access server (“NAS”) and provides the remote users with desktop client software for their computers. The telecommuters can then dial a toll-free number to attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a companies multiple fixed sites over a public network such as the Internet.

The process software is transported over the VPN via tunneling which is the process of placing an entire packet within another packet and sending it over the network. The protocol of the outer packet is understood by the network and both points, called tunnel interfaces, where the packet enters and exits the network.

Turning to FIG. 3d, VPN deployment process starts (360) by determining if a VPN for remote access is required (361). If it is not required, then proceed to (362). If it is required, then determine if the remote access VPN exits (364).

If a VPN does exist, then the VPN deployment process proceeds (365) to identify a third party provider that will provide the secure, encrypted connections between the company's private network and the company's remote users (376). The company's remote users are identified (377). The third party provider then sets up a network access server (“NAS”) (378) that allows the remote users to dial a toll free number or attach directly via a broadband modem to access, download and install the desktop client software for the remote-access VPN (379).

After the remote access VPN has been built or if it has been previously installed, the remote users can access the process software by dialing into the NAS or attaching directly via a cable or DSL modem into the NAS (365). This allows entry into the corporate network where the process software is accessed (366). The process software is transported to the remote user's desktop over the network via tunneling. That is the process software is divided into packets and each packet including the data and protocol is placed within another packet (367). When the process software arrives at the remote user's desktop, it is removed from the packets, reconstituted and then is executed on the remote users desktop (368).

A determination is made to see if a VPN for site to site access is required (362). If it is not required, then proceed to exit the process (363). Otherwise, determine if the site to site VPN exists (369). If it does exist, then proceed to (372). Otherwise, install the dedicated equipment required to establish a site to site VPN (370). Then, build the large scale encryption into the VPN (371).

After the site to site VPN has been built or if it had been previously established, the users access the process software via the VPN (372). The process software is transported to the site users over the network via tunneling. That is the process software is divided into packets and each packet including the data and protocol is placed within another packet (374). When the process software arrives at the remote user's desktop, it is removed from the packets, reconstituted and is executed on the site users desktop (375). Proceed to exit the process (363).

### Computer-Readable Media Embodiments

In another embodiment of the invention, logical processes according to the invention and described herein are encoded on or in one or more computer-readable media. Some computer-readable media are read-only (e.g. they must be initially programmed using a different device than that which is ultimately used to read the data from the media), some are write-only (e.g. from a the data encoders perspective they can only be encoded, but not read simultaneously), or read-write. Still some other media are write-once, read-many-times.

Some media are relatively fixed in their mounting mechanisms, while others are removable, or even transmittable. All computer-readable media form two types of systems when encoded with data and/or computer software: (a) when removed from a drive or reading mechanism, they are memory devices which generate useful data-driven outputs when stimulated with appropriate electromagnetic, electronic, and/or optical signals; and (b) when installed in a drive or reading device, they form a data repository system accessible by a computer.

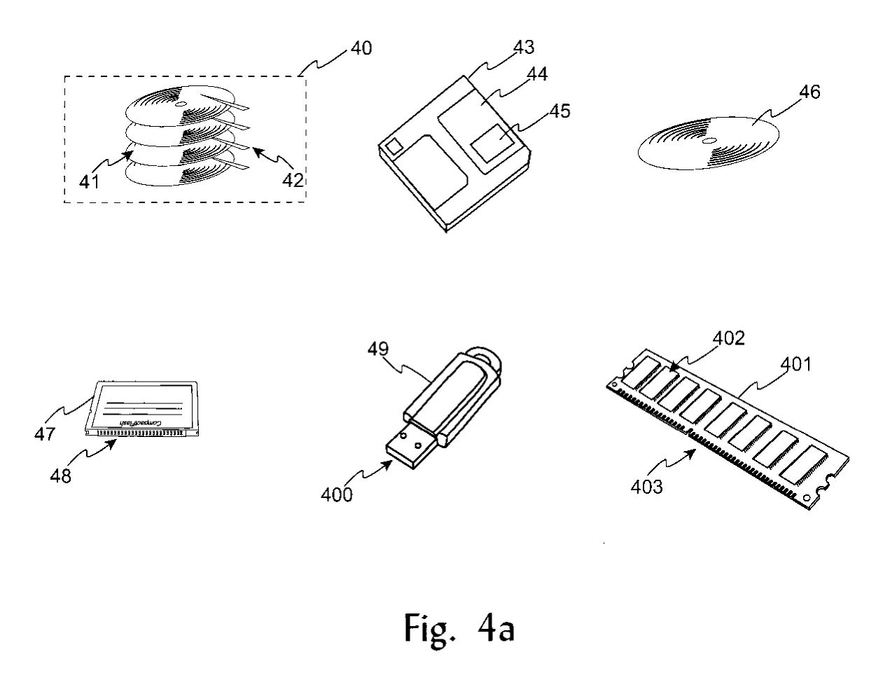

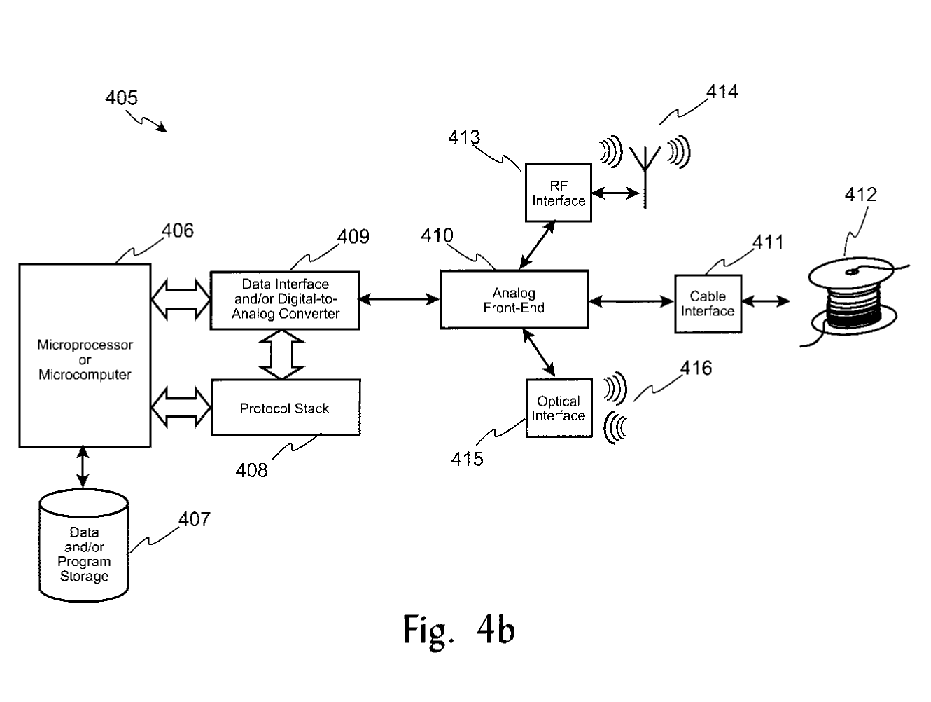

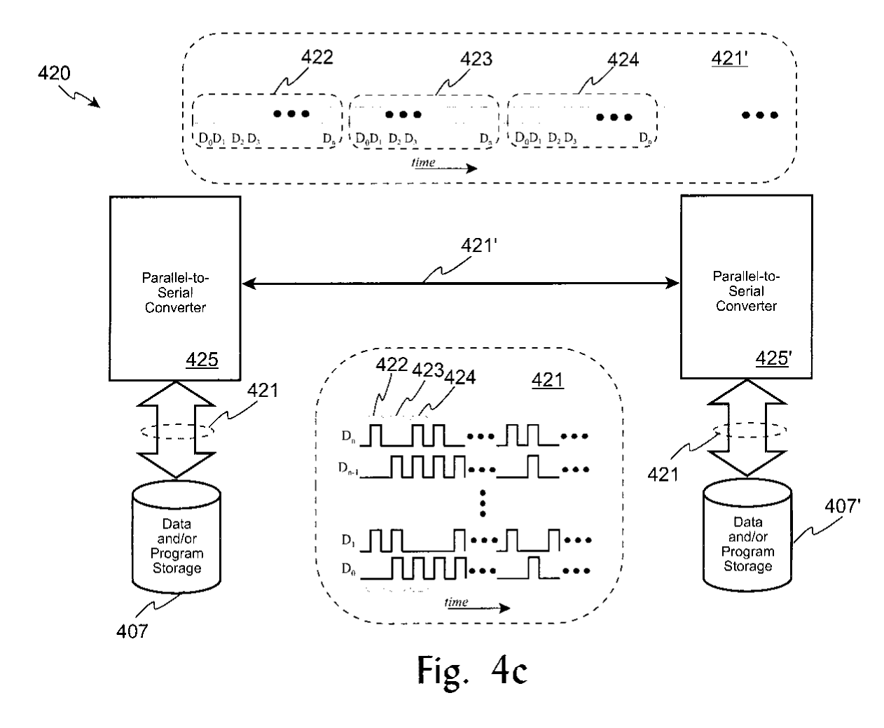

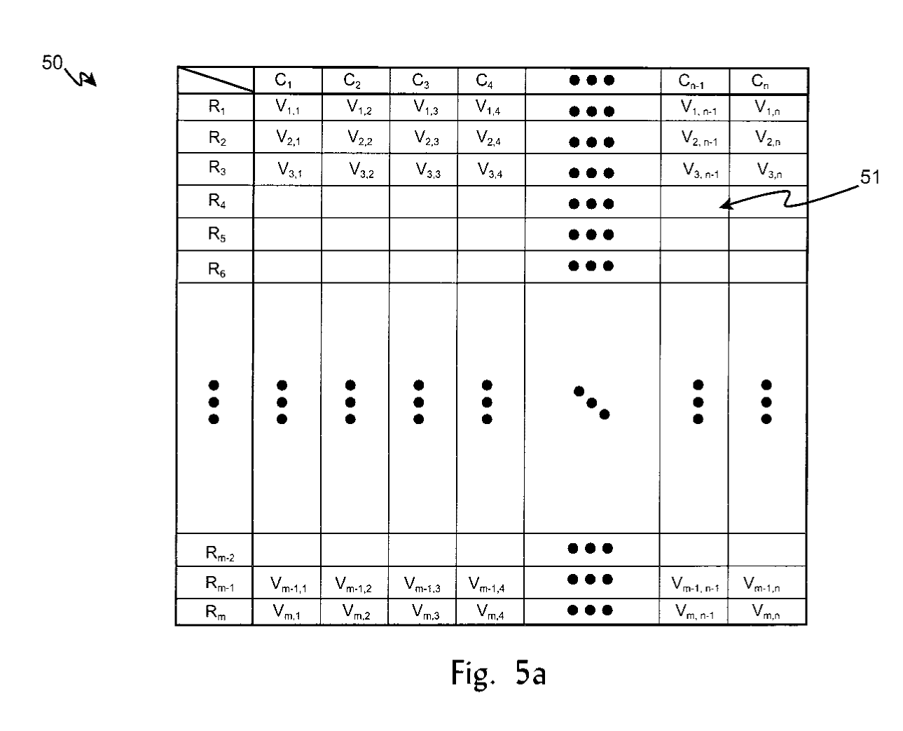

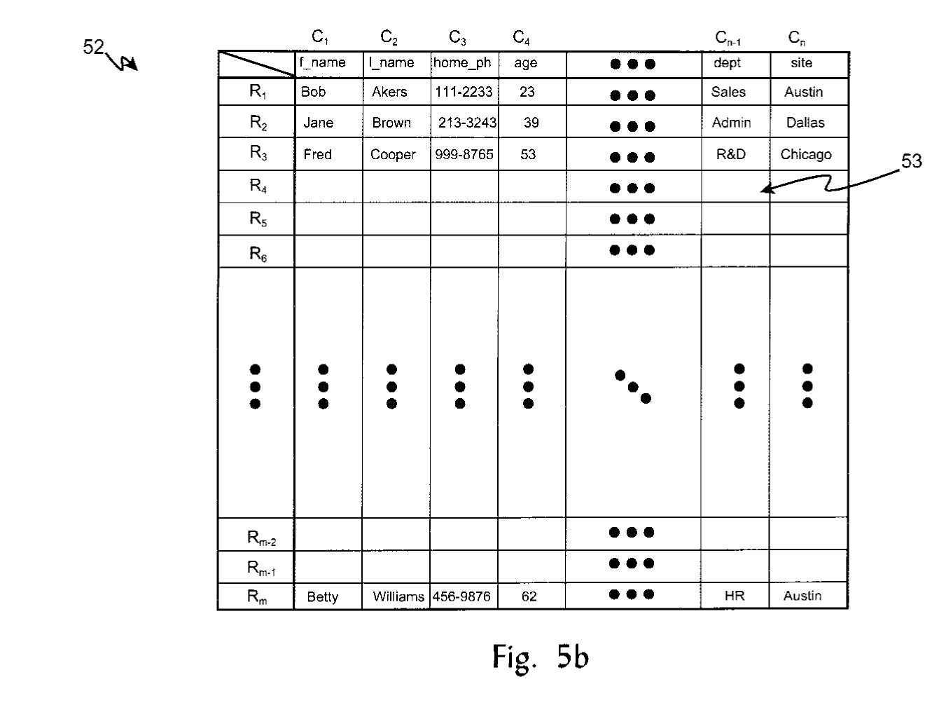

FIG. 4a illustrates some computer readable media including a computer hard drive (40) having one or more magnetically encoded platters or disks (41), which may be read, written, or both, by one or more heads (42). Such hard drives are typically semi-permanently mounted into a complete drive unit, which may then be integrated into a configurable computer system such as a Personal Computer, Server Computer, or the like.

Similarly, another form of computer readable media is a flexible, removable “floppy disk” (43), which is inserted into a drive which houses an access head. The floppy disk typically includes a flexible, magnetically encodable disk which is accessible by the drive head through a window (45) in a sliding cover (44).

A Compact Disk (“CD”) (46) is usually a plastic disk which is encoded using an optical and/or magneto-optical process, and then is read using generally an optical process. Some CD's are read-only (“CD-ROM”), and are mass produced prior to distribution and use by reading-types of drives. Other CD's are writable (e.g. “CD-RW”, “CD-R”), either once or many time. Digital Versatile Disks (“DVD”) are advanced versions of CD's which often include double-sided encoding of data, and even multiple layer encoding of data. Like a floppy disk, a CD or DVD is a removable media.

Another common type of removable media are several types of removable circuit-based (e.g. solid state) memory devices, such as Compact Flash (“CF”) (47), Secure Data (“SD”), Sony's MemoryStick, Universal Serial Bus (“USB”) FlashDrives and “Thumbdrives” (49), and others. These devices are typically plastic housings which incorporate a digital memory chip, such as a battery-backed random access chip (“RAM”), or a Flash Read-Only Memory (“FlashROM”). Available to the external portion of the media is one or more electronic connectors (48, 400) for engaging a connector, such as a CF drive slot or a USB slot. Devices such as a USB FlashDrive are accessed using a serial data methodology, where other devices such as the CF are accessed using a parallel methodology. These devices often offer faster access times than disk-based media, as well as increased reliability and decreased susceptibility to mechanical shock and vibration. Often, they provide less storage capability than comparably priced disk-based media.

Yet another type of computer readable media device is a memory module (403), often referred to as a SIMM or DIMM. Similar to the CF, SD, and FlashDrives, these modules incorporate one or more memory devices (402), such as Dynamic RAM (“DRAM”), mounted on a circuit board (401) having one or more electronic connectors for engaging and interfacing to another circuit, such as a Personal Computer motherboard. These types of memory modules are not usually encased in an outer housing, as they are intended for installation by trained technicians, and are generally protected by a larger outer housing such as a Personal Computer chassis.

Turning now to FIG. 4b, another embodiment option (405) of the present invention is shown in which a computer-readable signal is encoded with software, data, or both, which implement logical processes according to the invention. FIG. 4b is generalized to represent the functionality of wireless, wired, electro-optical, and optical signaling systems. For example, the system shown in FIG. 4b can be realized in a manner suitable for wireless transmission over Radio Frequencies (“RF”), as well as over optical signals, such as InfraRed Data Arrangement (“IrDA”). The system of FIG. 4b may also be realized in another manner to serve as a data transmitter, data receiver, or data transceiver for a USB system, such as a drive to read the aforementioned USB FlashDrive, or to access the serially-stored data on a disk, such as a CD or hard drive platter.

In general, a microprocessor or microcontroller (406) reads, writes, or both, data to/from storage for data, program, or both (407). A data interface (409), optionally including a digital-to-analog converter, cooperates with an optional protocol stack (408), to send, receive, or transceive data between the system front-end (410) and the microprocessor (406). The protocol stack is adapted to the signal type being sent, received, or transceived. For example, in a Local Area Network (“LAN”) embodiment, the protocol stack may implement Transmission Control Protocol/Internet Protocol (“TCP/IP”). In a computer-to-computer or computer-to-periperal embodiment, the protocol stack may implement all or portions of USB, “FireWire”, RS-232, Point-to-Point Protocol (“PPP”), etc.

The system's front-end, or analog front-end, is adapted to the signal type being modulated, demodulate, or transcoded. For example, in an RF-based (413) system, the analog front-end comprises various local oscillators, modulators, demodulators, etc., which implement signaling formats such as Frequency Modulation (“FM”), Amplitude Modulation (“AM”), Phase Modulation (“PM”), Pulse Code Modulation (“PCM”), etc. Such an RF-based embodiment typically includes an antenna (414) for transmitting, receiving, or transceiving electro-magnetic signals via open air, water, earth, or via RF wave guides and coaxial cable. Some common open air transmission standards are BlueTooth, Global Services for Mobile Communications (“GSM”), Time Division Multiple Access (“TDMA”), Advanced Mobile Phone Service (“AMPS”), and Wireless Fidelity (“Wi-Fi”).

In another example embodiment, the analog front-end may be adapted to sending, receiving, or transceiving signals via an optical interface (415), such as laser-based optical interfaces (e.g. Wavelength Division Multiplexed, SONET, etc.), or Infra Red Data Arrangement (“IrDA”) interfaces (416). Similarly, the analog front-end may be adapted to sending, receiving, or transceiving signals via cable (412) using a cable interface, which also includes embodiments such as USB, Ethernet, LAN, twisted-pair, coax, Plain-old Telephone Service (“POTS”), etc.

Signals transmitted, received, or transceived, as well as data encoded on disks or in memory devices, may be encoded to protect it from unauthorized decoding and use. Other types of encoding may be employed to allow for error detection, and in some cases, correction, such as by addition of parity bits or Cyclic Redundancy Codes (“CRC”). Still other types of encoding may be employed to allow directing or “routing” of data to the correct destination, such as packet and frame-based protocols.

FIG. 4c illustrates conversion systems which convert parallel data to and from serial data. Parallel data is most often directly usable by microprocessors, often formatted in 8-bit wide bytes, 16-bit wide words, 32-bit wide double words, etc. Parallel data can represent executable or interpretable software, or it may represent data values, for use by a computer. Data is often serialized in order to transmit it over a media, such as a RF or optical channel, or to record it onto a media, such as a disk. As such, many computer-readable media systems include circuits, software, or both, to perform data serialization and re-parallelization.

Parallel data (421) can be represented as the flow of data signals aligned in time, such that parallel data unit (byte, word, d-word, etc.) (422, 423, 424) is transmitted with each bit D₀-Dₙ being on a bus or signal carrier simultaneously, where the “width” of the data unit is n−1. In some systems, D₀ is used to represent the least significant bit (“LSB”), and in other systems, it represents the most significant bit (“MSB”). Data is serialized (421) by sending one bit at a time, such that each data unit (422, 423, 424) is sent in serial fashion, one after another, typically according to a protocol.

As such, the parallel data stored in computer memory (407, 407′) is often accessed by a microprocessor or Parallel-to-Serial Converter (425, 425′) via a parallel bus (421), and exchanged (e.g. transmitted, received, or transceived) via a serial bus (421′). Received serial data is converted back into parallel data before storing it in computer memory, usually. The serial bus (421′) generalized in FIG. 4c may be a wired bus, such as USB or Firewire, or a wireless communications medium, such as an RF or optical channel, as previously discussed.

In these manners, various embodiments of the invention may be realized by encoding software, data, or both, according to the logical processes of the invention, into one or more computer-readable mediums, thereby yielding a product of manufacture and a system which, when properly read, received, or decoded, yields useful programming instructions, data, or both, including, but not limited to, the computer-readable media types described in the foregoing paragraphs.

### CONCLUSION

While certain examples and details of a preferred embodiment have been disclosed, it will be recognized by those skilled in the are that variations in implementation such as use of different programming methodologies, computing platforms, and processing technologies, may be adopted without departing from the spirit and scope of the present invention. Therefore, the scope of the invention should be determined by the following claims.

What is claimed is:

1. A portion of a computer system comprising:
a receiver for receiving a database query data selection command;
a parser for determining if a partial column name has been specified in a phrase or option of the command, and for extracting a targeted database or data table name from the command responsive to determining that a partial column name has been specified;
an accesser for searching and finding in a database system catalog one or more column names matching said partial name specification; and
a database data selector for selecting and returning data from one or more columns having said matching name or names.

2. The system as set forth in claim 1 wherein said database query comprises a Structured Query Language (“SQL”) SELECT command.

3. The system as set forth in claim 1 wherein said receiver is configured to receive a command from a user console.

4. The system as set forth in claim 1 wherein said receiver is configured to receive a command from an application programming interface.

5. The system as set forth in claim 1 further comprising an error handler for throwing an error responsive to finding no matching column names in the system catalog.

6. The system as set forth in claim 1 further comprising a multiple-match resolver configured to return a plurality of matching columns of data according to a pre-determined rule.

7. The system as set forth in claim 6 wherein said rule comprises returning data according to order of creation of the columns.

8. The system as set forth in claim 6 wherein said rule comprises returning data according to alphabetical order of the names of the columns.

9. The system as set forth in claim 6 wherein said rule comprises returning data according to numeric order of the names of the columns.

10. The system as set forth in claim 1 further comprising an error handler for throwing an error responsive to said partial column name specification matching a name alias setting within said command.

11. The system as set forth in claim 1 wherein at least one of said receiver, parser, accesser, and database data selector are disposed within a database query engine component of a computer system.

12. The system as set forth in claim 1 wherein said database query engine comprises an Structured Query Language database engine.

13. A computer-based method comprising:
receiving a database query data selection command from a requester;
determining if a partial column name has been specified in a phrase or option of the command, and for extracting a targeted database or data table name from the command responsive to determining that a partial column name has been specified;
searching a database system catalog to find one or more column names matching said partial name specification;
selecting data from one or more columns having said matching name or names in said targeted database or data table; and
returning the selected data to the requester.

14. The method as set forth in claim 13 wherein said database query comprises a Structured Query Language (“SQL”) SELECT command.

15. The method as set forth in claim 13 further comprising resolving multiple column name matches by returning a plurality of matching columns of data according to a pre-determined rule.

16. The method as set forth in claim 16 wherein said rule comprises a rule selected from the group of returning data according to order of creation of the columns, returning data according to alphabetical order of the names of the columns, and returning data according to numeric order of the names of the columns.

17. An article of manufacture comprising:
a computer-readable medium suitable for encoding computer-executable software; and
software encoded in said medium for performing the steps of:
(a) receiving a database query data selection command from a requester;
(b) determining if a partial column name has been specified in a phrase or option of the command, and for extracting a targeted database or data table name from the command responsive to determining that a partial column name has been specified;
(c) searching a database system catalog to find one or more column names matching said partial name specification;
(d) selecting data from one or more columns having said matching name or names in said targeted database or data table; and
(e) returning the selected data to the requester.

18. The article as set forth in claim 17 wherein said database query comprises a Structured Query Language (“SQL”) SELECT command.

19. The article as set forth in claim 17 further comprising software for resolving multiple column name matches by returning a plurality of matching columns of data according to a pre-determined rule.

20. The article as set forth in claim 19 wherein said rule comprises a rule selected from the group of returning data according to order of creation of the columns, returning data according to alphabetical order of the names of the columns, and returning data according to numeric order of the names of the columns.
